(19) United States
(12) Patent Application Publication
(10) Pub. No.: US 2012/0076562 A1
(43) Pub. Date: Mar. 29, 2012

(54) RECORDING APPARATUS

(75) Inventors: Kenji Oshima, Kamiina-gun (JP); Yuji Miyamoto, Shiojiri-shi (JP); Masayuki Horikawa, Matsumoto-shi (JP)

(73) Assignee: SEIKO EPSON CORPORATION, Tokyo (JP)

(21) Appl. No.: 13/246,738

(22) Filed: Sep. 27, 2011

(30) Foreign Application Priority Data
Sep. 29, 2010 (JP) 2010-218341

(51) Int. Cl. B41J 11/44

(52) U.S. Cl. 400/76

(57) ABSTRACT

A recording apparatus includes a recording portion which executes recording on a medium, a feeding portion which feeds the medium to the recording portion, a discharge portion on which the medium on which the recording has been executed is discharged, a base portion which holds the recording portion, the feeding portion, and the discharge portion, an exterior member which covers at least a portion of the base portion, an information input portion which instructs to execute the recording, a pair of holding portions which are provided on the base portion, bridge the information input portion, hold the information input portion on the base portion, and a fixing mechanism which fixes the information input portion to the pair of the holding portions in an axial direction of the information input portion.

### BACKGROUND

1. Technical Field

The present invention relates to a recording apparatus.

2. Related Art

In recent years, demand of utilization of a simple printer has been accelerated. The utilization of the simple printer includes utilization of a printer which is one of recording apparatuses as a copying machine without connecting the printer to a personal computer, for example. With the acceleration of such demand, a printer including an information input portion with which the printer can directly receive an instruction to execute recording has been known, as described in JP-A-2010-36397.

The information input portion is needed to be exposed from an exterior member forming exterior appearance in order to ensure visibility. Therefore, in existing techniques, the information input portion is held on the exterior member. Further, in the existing techniques, the information input portion is axially supported by the exterior member in a rotationally movable manner in order to improve visibility when used.

The printer includes a recording portion which executes recording on a medium, a feeding portion which feeds the medium to the recording portion, and a discharge portion on which the medium onto which recording has been executed is discharged as constituent components influencing on recording accuracy. As described in JP-A-2004-10279, a design in which these constituent components are made to be held on a base portion as one member so that error of each part is made smaller and resultingly to make error of the entire product smaller has been known.

As described in JP-A-2010-36397, when the information input portion is made to be held on the exterior member, it is necessary that the exterior member have rigidity with more cost. However, if the information input portion is also made to be held on the base portion as in the constituent components in JP-A-2004-10279, the exterior member is not required to have rigidity.

However, if the base portion is made to have rigidity which the existing exterior member has only, it is necessary that a part of the base portion, which holds the information input portion, has larger rigidity. Therefore, there arises a problem that cost of the base portion or the like is increased. Further, the information input portion is manually rotationally-moved by a user unlikely the recording portion, the feeding portion, and the discharge portion. Therefore, consideration to a possibility that a large force is applied to the information input portion by the user has been needed.

### SUMMARY

An advantage of some aspects of the invention is to provide a recording apparatus which makes it possible to complement rigidity of a base portion with configurations of other members and in which the base portion is made to hold an information input portion.

The invention can be realized in the following forms or as the following Application Examples so as to solve at least one of the above problems.

### Application Example 1

A recording apparatus according to the Application Example includes: a recording portion which executes recording on a medium, a feeding portion which feeds the medium to the recording portion, a discharge portion on which the medium on which the recording has been executed is discharged, a base portion which holds the recording portion, the feeding portion, and the discharge portion, an exterior member which covers at least a portion of the base portion, an information input portion which instructs to execute the recording, a pair of holding portions which are provided on the base portion, bridge the information input portion, hold the information input portion such that the information input portion is rotationally movable with respect to the base portion, and a fixing mechanism which fixes the information input portion to the pair of the holding portions in an axial direction of a rotational shaft of the information input portion.

According to the above Application Example, the information input portion is bridged between and held by the holding portions. With this, the information input portion serves as a beam so as to complement rigidity of the holding portions. When a force of falling one holding portion is applied to the holding portion over which the information input portion is bridged, not only the one holding portion is deformed with the force but also the other holding portion over which the information input portion is bridged is deformed through the information input portion. With this, the applied force can be dispersed. Accordingly, an external load is dispersed so as to complement the rigidity of the base portion.

### Application Example 2

In the above Application Example, it is preferable that the recording portion have a carriage on which a recording head is mounted and a supporting portion which supports the carriage, and the pair of holding portions be provided so as to be separated from the supporting portion.

According to the above Application Example, effects obtained in the Application Example 1 can be obtained on a portion of the carriage having rigidity, which is separated from the supporting portion. Accordingly, rigidity can be preferably increased at a portion having small rigidity.

### Application Example 3

In the above Application Example, it is preferable that the recording apparatus further include a pressurization member which is provided between the information input portion and the holding portions and pressurizes the information input portion and the holding portions.

According to the above Application Example, the above effects can be obtained with a simple configuration.

### Application Example 4

In the above Application Example, it is preferable that the shaft of the information input portion be held on the holding portions in a rotationally movable manner.

According to the above Application Example, the above effects can be obtained on the information input portion which is rotationally movable.

### Application Example 5

In the above Application Example, it is preferable that the shaft of the information input portion have a pair of shaft disengagement prevention portions which prevent the shaft from being disengaged from the holding portions in the axial direction of the shaft, and the pair of shaft disengagement prevention portions and the pair of holding portions be pressurized against each other.

According to the above Application Example, the above effects can be obtained with a simple configuration.

### Application Example 6

In the above Application Example, it is preferable that the pair of shaft disengagement prevention portions and the pair of holding portions be pressurized against each other in a state where the holding portions are elastically deformed in the axial direction of the rotational shaft of the information input portion.

According to the above Application Example, the above effects can be obtained with a simple configuration.

### BRIEF DESCRIPTION OF THE DRAWINGS

The invention will be described with reference to the accompanying drawings, wherein like numbers reference like elements.

FIG. 1 is a perspective view of a recording apparatus.

FIG. 2 is a perspective view of a recording apparatus unit.

FIG. 3A is a cross-sectional view illustrating main parts centered on one holding portion on a cross section cut along a line IIIA-IIIA in FIG. 2 on which an exterior member is arranged. FIG. 3B is a corresponding view of FIG. 3A illustrating an operation portion bridged between two holding portions and the holding portions.

FIG. 4A is a corresponding view of FIG. 3A in a second information input portion state. FIG. 4B is a corresponding view of FIG. 3B in the second information input portion state.

FIG. 5A is a cross-sectional view excluding the operation portion from a cross section cut along a line VA-VA in FIG. 3A. FIG. 5B is a cross-sectional view excluding the operation portion from a cross section cut along a line VB-VB in FIG. 4A.

FIGS. 6A and 6B are conceptual views illustrating a positional relationship between a first holding portion and a shaft disengagement prevention portion.

FIG. 7 is a cross-sectional view cut along a line VII-VII in FIG. 4A.

FIG. 8 is a cross-sectional view cut along the line VA-VA in FIG. 3A.

FIG. 9 is a cross-sectional view cut along the line VB-VB in FIG. 4A.

FIG. 10 is a conceptual view illustrating a positional relationship between the first holding portion and a tilt portion.

FIG. 11 is a corresponding view of FIG. 4A in a third embodiment.

### DESCRIPTION OF EXEMPLARY EMBODIMENTS

### First Embodiment

Hereinafter, a first embodiment of a recording apparatus according to the invention is described with reference to the drawings.

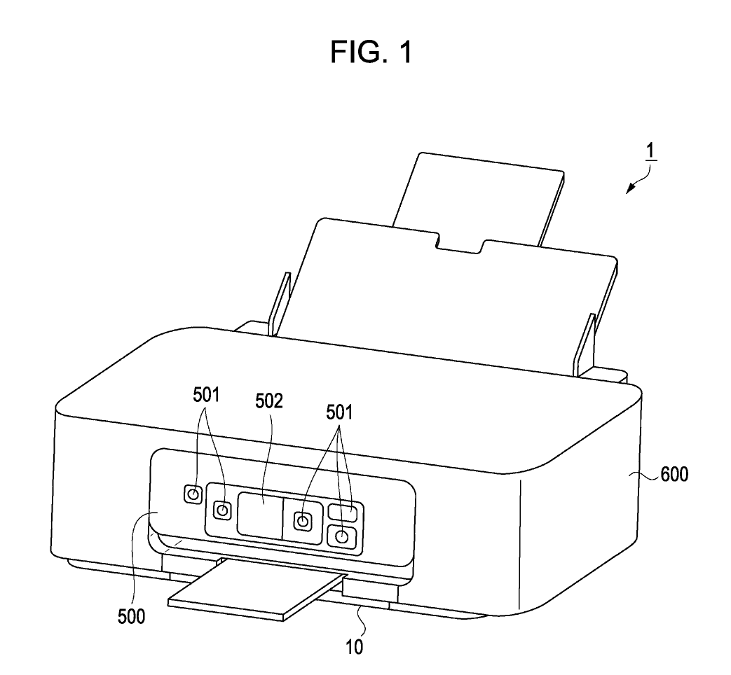

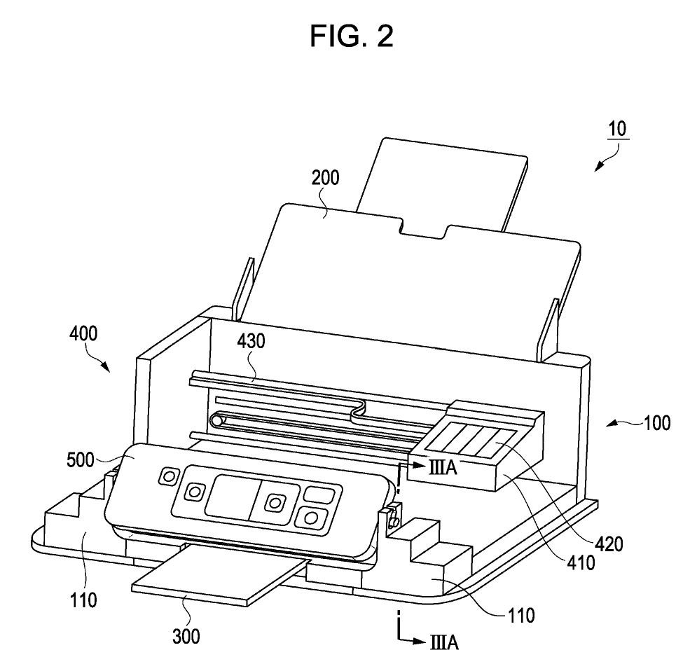

A configuration of the recording apparatus according to the embodiment is described below with reference to FIG. 1 and FIG. 2. FIG. 1 is a perspective view of the recording apparatus. FIG. 2 is a perspective view of a recording apparatus unit.

As illustrated in FIG. 1, a recording apparatus 1 includes a recording apparatus unit 10, an information input portion 500, and an exterior member 600.

The information input portion 500 makes it possible to instruct to execute recording by the recording apparatus 1 only without using an external operation apparatus such as a personal computer. Further, the information input portion 500 includes operation buttons 501 and an operation screen 502. Power-on, the instruction to execute recording, various operation settings are performed with the operation buttons 501. Various pieces of information on the various operation settings are displayed on the operation screen 502.

Further, as will be described in detail later, the information input portion 500 can be held at different angles between the following states. That is, the information input portion 500 can be held in a state where a face on which the operation buttons 501 and the operation screen 502 are arranged is held at a tilt as illustrated in FIG. 2 and a state where the face on which the operation buttons 501 and the operation screen 502 are arranged is held substantially vertically as illustrated in FIG. 1.

In the specification, the state where the face on which the operation buttons 501 and the operation screen 502 are arranged is held at a tilt as illustrated in FIG. 2 is referred to as a “first information input portion state”. On the other hand, the state where the face on which the operation buttons 501 and the operation screen 502 are arranged is held substantially vertically as illustrated in FIG. 1 is referred to as a “second information input portion state”.

It is to be noted that in the embodiment, the information input portion 500 employs a mode in which information is input with buttons. However, the invention is not limited to the mode in which information is input with the buttons as long as a mode in which information can be input is employed. For example, a touch-panel on which a user inputs information by touching an operation screen may be employed.

The recording apparatus unit 10 is a mechanism as a core of the recording apparatus 1. As illustrated in FIG. 2, the recording apparatus unit 10 is constituted by a feeding portion 200, a discharge portion 300, and a recording portion 400 which are held on a base portion 100. It is to be noted that the base portion 100 is preferably formed with a resin or a metal which is lightweight and has elasticity in order to realize lightweight of the recording apparatus 1 and assembling easiness of members.

As illustrated in FIG. 2, the feeding portion 200 is formed into a plate shape on which a medium as a discharge target before recording is executed thereon is placed. The feeding portion 200 is held on the base portion 100 so as to be accommodated therein.

Further, the discharge portion 300 is formed into a plate shape on which the medium as the discharge target after recording has been executed thereon is placed. The discharge portion 300 is held on the base portion 100 so as to be accommodated therein. Hereinafter, in FIG. 2, a side of the recording apparatus unit 10 at which the discharge portion 300 is held is referred to as “front” and a side of the recording apparatus unit 10 at which the feeding portion 200 is held is referred to as “rear”.

Further, the recording portion 400 is constituted by a carriage 410, a carriage shaft 430, and a medium supporting member (not illustrated). As illustrated in FIG. 2, the carriage shaft 430 is held on the base portion 100 and the carriage 410 which is engaged with the carriage shaft 430 is configured to move along the carriage shaft 430. Further, the medium supporting member is also held on the base portion 100 so as to be opposed to a movement region of the carriage 410.

An ink cartridge 420 into which ink is filled is mounted on the carriage 410. Ink is fed to a recording head (not illustrated) with the ink cartridge 420. The recording head which discharges ink is mounted on the carriage 410.

The medium placed on the feeding portion 200 is transported to the recording portion 400 by a feeding roller (not illustrated). Further, the medium supporting member supports the medium such that the medium is opposed to the recording head when recording is executed. Subsequently, ink is discharged by the recording head (not illustrated) mounted on the carriage 410 so that recording is executed. Note that the carriage 410 moves in the direction perpendicular to the transportation direction. The medium on which ink has been discharged is transported to the discharge portion 300 by a discharge roller (not illustrated) and placed on the discharge portion 300.

It is to be noted that a serial system in which the recording head mounted on the carriage 410 as a constituent component of the recording portion 400 scans in the direction perpendicular to the transportation direction of the medium has been described. However, the invention is not limited to the above configuration as long as recording is executed onto the medium. For example, a line system in which the recording head is arranged over the width direction of the medium may be employed.

Further, a configuration in which the feeding portion 200 and the discharge portion 300 are formed into a plate shape has been described. However, the invention is not limited to the above configuration as long as the feeding portion 200 and the discharge portion 300 can hold the medium. For example, a configuration in which the feeding portion 200 and the discharge portion 300 are formed into a cassette shape may be employed.

Subsequently, a configuration in which the information input portion 500 is held on the base portion 100 is described as a characteristic configuration of the invention.

As illustrated in FIG. 2, the information input portion 500 is held by a pair of holding portions 110. The holding portions 110 correspond to both ends of the information input portion 500 and are arranged to stand in the substantially vertical direction so as to be integral with the base portion 100.

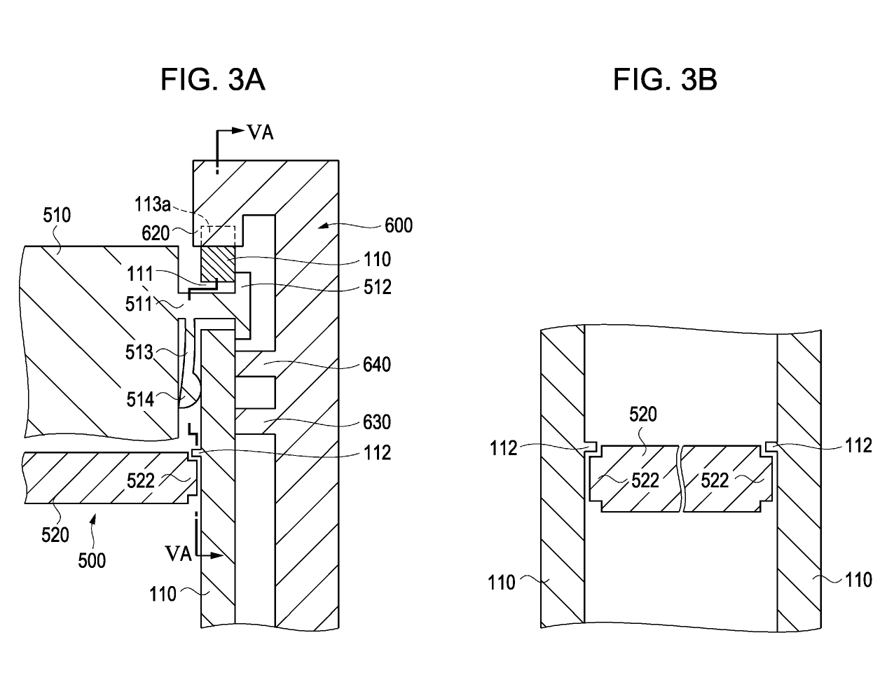

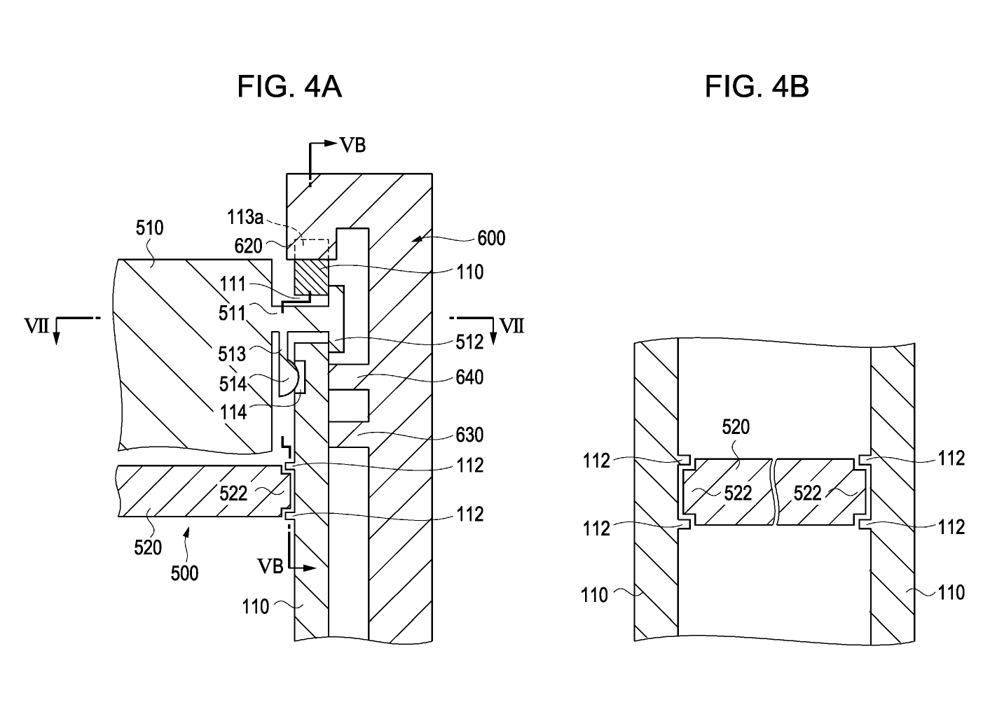

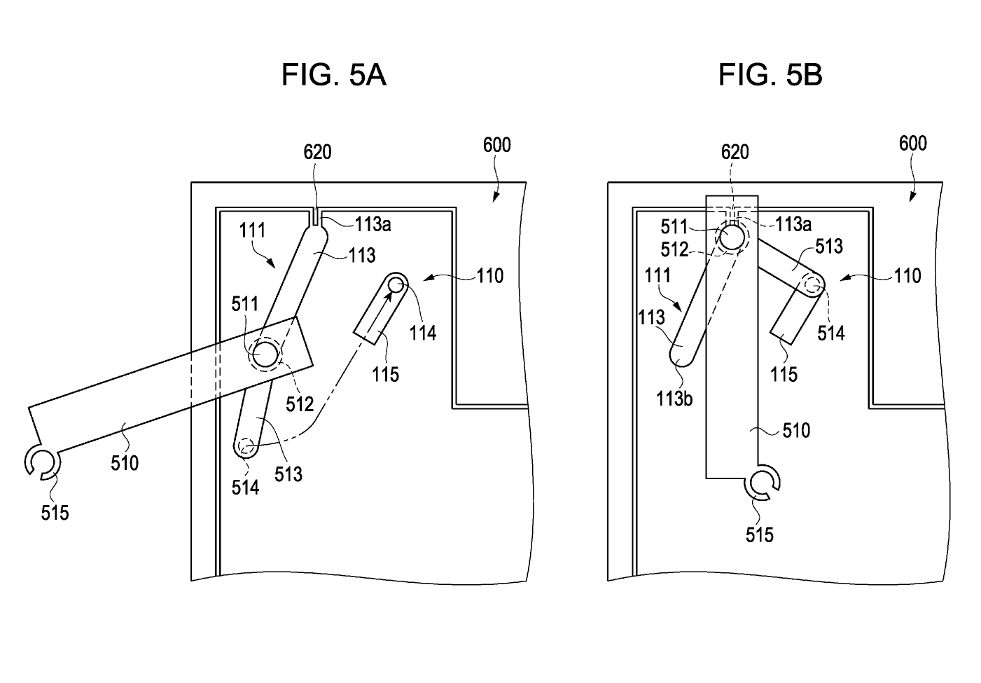

The configuration is further described in detail with reference to FIG. 3A to FIG. 5B. FIG. 3A is a cross-sectional view illustrating main parts centered on one holding portion on a cross section cut along a line IIIA-IIIA in FIG. 2 on which the exterior member 600 is arranged. FIG. 3B is a corresponding view of FIG. 3A illustrating an operation portion 520 bridged between two holding portions and the holding portions 110. FIG. 4A is a corresponding view of FIG. 3A in the second information input portion state. FIG. 4B is a corresponding view of FIG. 3B in the second information input portion state. FIG. 5A is a cross-sectional view excluding the operation portion 520 from a cross section cut along a line VA-VA in FIG. 3A. FIG. 5B is a cross-sectional view excluding the operation portion 520 from a cross section cut along a line VB-VB in FIG. 4A.

As illustrated in FIG. 3A and FIG. 4A, the information input portion 500 includes a tilt portion 510 and the operation portion 520. The tilt portion 510 includes the operation screen 502 and the operation buttons 501. An angle of the tilt portion 510 is changed with the operation portion 520 as illustrated in FIGS. 5A and 5B. When a user changes the angle of the tilt portion 510, the angle of the tilt portion 510 with respect to the base portion 100 can be changed by operating the operation portion 520. It is to be noted that the operation of the operation portion 520 when the angle of the tilt portion 510 is changed is described later.

The tilt portion 510 is formed into a flattened shape. The tilt portion 510 has shafts 511 projecting to the sides of the holding portions 110, as illustrated in FIG. 3A and FIG. 4A.

Further, outer shapes of free ends of the shafts 511 of the tilt portion 510 are made larger. The shafts 511 of the tilt portion 510 have shaft disengagement prevention portions 512 which prevent the shafts 511 from being disengaged from first holding portions 111 in the shaft extending direction.

As illustrated in FIGS. 5A and 5B, the shafts 511 of the tilt portion 510 are fitted into the first holding portions 111 so that the tilt portion 510 is bridged between and held by the first holding portions 111. The first holding portions 111 are formed by cutout portions 113 formed on the pair of holding portions 110.

As illustrated in FIGS. 3A and 3B and FIGS. 4A and 4B, the operation portion 520 has locking portions 522 projecting to the sides of the holding portions 110. Further, the locking portions 522 are held by second holding portions 112 so that the operation portion 520 are bridged between and held by the second holding portions 112. The second holding portions 112 are formed so as to project from the pair of holding portions 110.

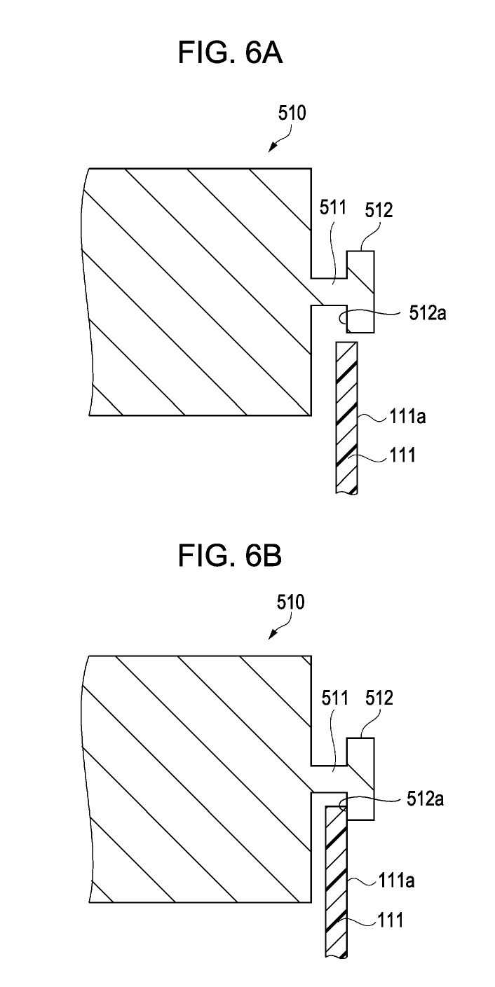

Next, a configuration of the tilt portion 510 which is suppressed from moving with respect to the first holding portions 111 is described. FIGS. 6A and 6B are conceptual views illustrating a positional relationship between the first holding portion 111 and the shaft disengagement prevention portion 512. FIG. 6A illustrates a state before the shafts 511 of the tilt portion 510 are held on the first holding portions 111. FIG. 6B illustrates a state after the shafts 511 of the tilt portion 510 is held on the first holding portions 111.

As illustrated in FIG. 6A, in the state before the shafts 511 of the tilt portion 510 are held on the first holding portions 111, faces 512a of the shaft disengagement prevention portions 512 at the side of the tilt portion are located at the side of the tilt portion 510 with respect to faces 111a of the first holding portions 111 at the opposite side to the side of the tilt portion.

As illustrated in FIG. 6B, if the shafts 511 of the tilt portion 510 are held on the first holding portions 111, the faces 512a of the shaft disengagement prevention portions 512 at the side of the tilt portion are opposed to the faces 111a of the first holding portions 111 at the opposite side to the side of the tilt portion. The first holding portions 111 made of a material having elasticity such as a resin have elasticity. Therefore, if the shafts 511 of the tilt portion 510 are held on the first holding portions 111, the first holding portions 111 and the shaft disengagement prevention portions 512 have the following positional relationship. That is, the faces 111a of the first holding portions 111 at the opposite side to the side of the tilt portion pressurize the faces 512a of the shaft disengagement prevention portions 512 at the side of the tilt portion.

That is to say, the tilt portion 510 is held on the first holding portions 111 in a state where both ends of the tilt portion 510 are pulled. Accordingly, the tilt portion 510 is suppressed from moving with respect to the first holding portions 111 in the direction parallel with an axial direction of the shafts 511 of the tilt portion 510. As the tilt portion 510 is bridged between the first holding portions 111 in this manner, the tilt portion 510 serves as a beam on the first holding portions 111. For example, when a falling force is applied to one first holding portion 111, not only the one first holding portion 111 is deformed with the applied force but also the other first holding portion 111 is deformed through the tilt portion 510. With this, the applied force can be dispersed. In such a manner, an external load is dispersed so as to complement rigidity of the base portion 100 with an action of the tilt portion 510 as the beam on the pair of the first holding portions 111.

Next, a positional relationship between the exterior member 600 and the base portion 100 is described.

As illustrated in FIG. 4A, the holding portions 110 and the exterior member 600 abut against each other in the direction parallel with the axial direction of the shafts 511 of the tilt portion 510.

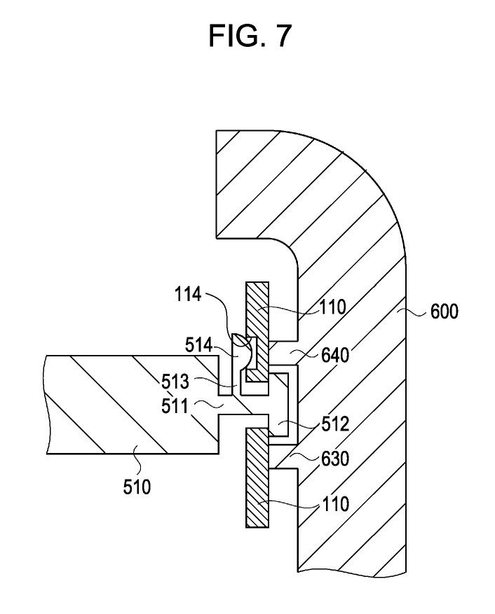

As illustrated in FIG. 4A and FIG. 7 as a cross-sectional view cut along a line VII-VII in FIG. 4A, the exterior member 600 includes abutment portions 630, 640. As illustrated in FIG. 7, the abutment portions 630, 640 of the exterior member 600 abut against the holding portions 110 at a pair of positions sandwiching the shafts 511 of the tilt portion 510. In the embodiment, the abutment portions 630 abut against the holding portions 110 at the front side of the recording apparatus unit 10 with respect to the shafts 511 of the tilt portion 510. The abutment portions 640 abut against the holding portions 110 at the rear side of the recording apparatus unit 10 with respect to the shafts 511 of the tilt portion 510. The holding portions 110 and the exterior member 600 abut against each other in the direction parallel with an axial direction of the shafts 511 of the tilt portion 510. With this, the rigidity of the holding portions 110 can be complemented with the rigidity of the exterior member 600. Accordingly, the rigidity of the holding portions 110 of which rigidity has been complemented with the action of the beam of the tilt portion 510 can be further complemented.

Further, as illustrated in FIG. 4A, FIGS. 5A and 5B, and FIG. 7, the tilt portion 510 has projections 514 at front ends thereof and position fixing portions 513. The projections 514 project to the side of the holding portions 110. The position fixing portions 513 move in conjunction with the shafts 511 of the tilt portion 510.

Further, as illustrated in FIG. 4A and FIG. 5A, the holding portions 110 have position fixing target portions 114 into which the position fixing portions 513 are fitted. As illustrated in FIG. 4A and FIG. 5B, the projections 514 are fitted into the position fixing target portions 114 in the second information input portion state.

As illustrated in FIG. 4A and FIG. 7, the holding portions 110 are sandwiched between the projections 514 of the fixing portions 513 and the abutment portions 640 in the second information input portion state. The projections 514 are fitted into the position fixing target portions 114 in the second information input portion state. Therefore, the projections 514 and the abutment portions 640 are opposed to each other sandwiching the holding portions 110. With this, the holding portions 110 can be pressed by the projections 514 and the abutment portions 640 from both sides. Accordingly, the rigidity of the holding portions 110 can be further complemented by the tilt portion 510 and the exterior member 600.

Further, as illustrated in FIGS. 5A and 5B, the first holding portions 111 include cutout portions 113 having openings 113a into which the shafts 511 of the tilt portion 510 are fitted. As illustrated in FIGS. 5A and 5B, the exterior member 600 includes opening cover portions 620. When the exterior member 600 is attached to the holding portions 110, the opening cover portions 620 overlap with the openings 113a. It is to be noted that the opening cover portions 620 are provided so as to project from the openings 113a to the first holding portions 111. Therefore, the exterior member 600 prevents the shafts 511 of the tilt portion 510 from being disengaged through the openings 113a.

As described above, the exterior member 600 complements rigidity of the holding portions 110 at a plurality of places on the abutment portions 630, 640 and the opening cover portions 620.

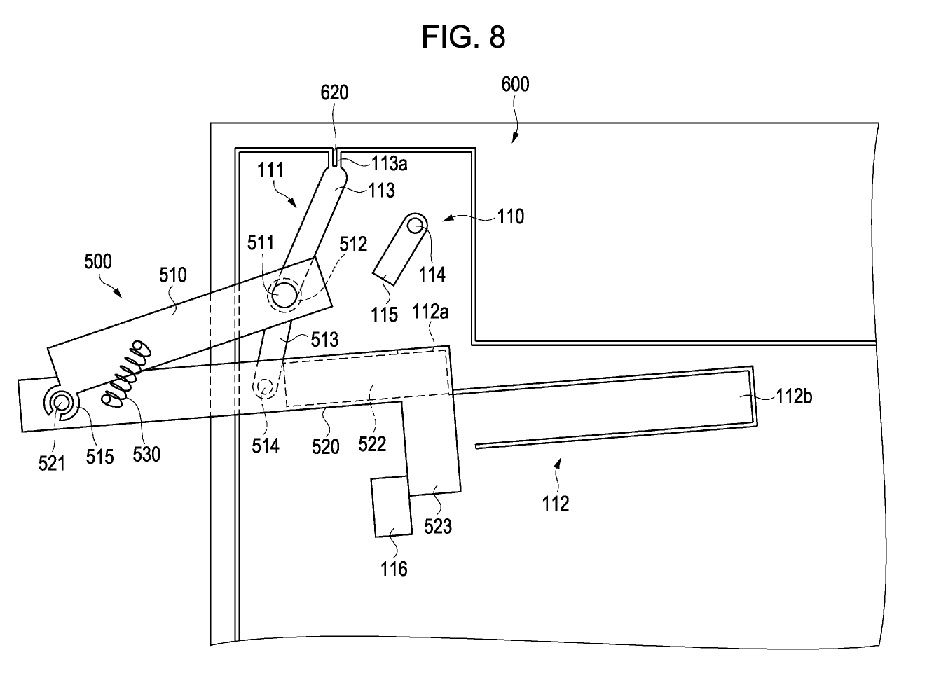

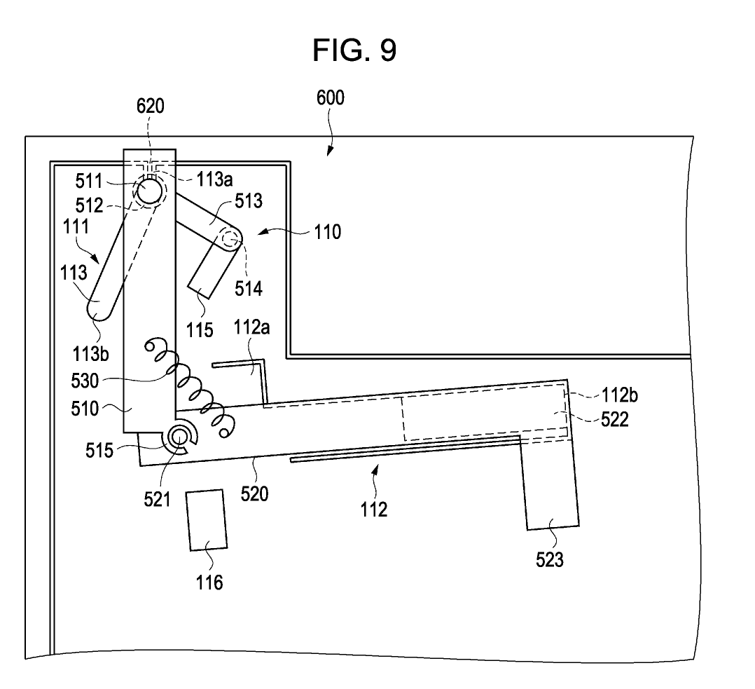

Subsequently, configurations of the first holding portions 111 and the second holding portions 112 are described in detail. Thereafter, an operation of the information input portion 500 from the first information input portion state to the second information input portion state is described. FIG. 8 is a cross-sectional view cut along the line VA-VA in FIG. 3A. FIG. 9 is a cross-sectional view cut along the line VB-VB in FIG. 4A.

As illustrated in FIG. 8 and FIG. 9, the first holding portions 111 are formed by the cutout portions 113. The cutout portions 113 are provided so as to extend in the obliquely downward direction from the openings 113a formed at upper portions toward the front side of the recording apparatus unit 10. It is to be noted that as illustrated in FIG. 9, ends of the cutout portions 113, which are provided so as to extend furthest in the obliquely downward direction to the front side, are referred to as cutout ends 113b.

The shafts 511 of the tilt portion 510 are fitted into the cutout portions 113 from the openings 113a in the direction perpendicular to the axial direction thereof. Further, as illustrated in FIG. 8 and FIG. 9, the shafts 511 of the tilt portion 510 operate while the cutout portions 113 serve as guides for the shafts 511.

The second holding portions 112 are formed so as to project from the holding portions 110 as illustrated in FIG. 3A and FIG. 4A. At this time, the second holding portions 112 are formed such that grooves extending in the front and rear direction of the recording apparatus unit 10 are formed as illustrated in FIG. 8 and FIG. 9. Further, as will be described below, the second holding portions 112 are configured to hold the locking portions 522 of the operation portion 520 at positions at the front side and the rear side of the recording apparatus unit 10. The second holding portions 112 are formed such that ends of the second holding portions 112 at the front side are opened and ends thereof at the rear side are closed. Further, the second holding portions 112 are configured to be gradually and obliquely higher toward the rear side. As the positional relationship between the first holding portions 111 and the second holding portions 112 in FIG. 8 and FIG. 9, the first holding portions 111 are arranged at “higher” positions than the second holding portions 112.

The second holding portions 112 are constituted by first engagement portions 112a and second engagement portions 112b. The first engagement portions 112a restrict positions of the locking portions 522 of the operation portion 520 in the first information input portion state as illustrated in FIG. 8. The second engagement portions 112b restrict positions of the locking portions 522 at the rear side and lower side with respect to the first engagement portions 112a in the second information input portion state as illustrated in FIG. 9. The first engagement portions 112a restrict the positions of the locking portions 522 in the upper direction and the rear direction. The second engagement portions 112b restrict the positions of the locking portions 522 in the upper and lower directions and the rear direction. The first engagement portions 112a and the second engagement portions 112b are coupled to each other so as to restrict the positions of the locking portions 522 in the upper direction.

Further, as already described above, as illustrated in FIG. 8, the holding portions 110 have the position fixing target portions 114 into which the projections 514 on the position fixing portions 513 are fitted. The position fixing target portions 114 have shapes into which the projections 514 are fitted. Further, grooves 115 are formed around the position fixing target portions 114 at positions opposed to the projections 514. The grooves 115 are arranged so as to extend in the obliquely downward direction from the positions at which the position fixing target portions 114 are formed to the front side.

Next, the operation of the information input portion 500 from the first information input portion state to the second information input portion state is described.

At first, the first information input portion state as illustrated in FIG. 8 is described. Ends of the locking portions 522 of the operation portion 520 at the upper side and the rear side are positioned by the first engagement portions 112a of the second holding portions 112.

Further, the operation portion 520 has a shaft 521 and the tilt portion 510 has a shaft bearing 515 into which the shaft 521 is fitted. If the shaft bearing 515 slidingly moves on a circumferential face of the shaft 521, the tilt portion 510 is configured to be capable of rotationally moving with respect to the operation portion 520.

The tilt portion 510 and the operation portion 520 are biased by a coil spring 530 such that a face of the tilt portion 510 and the operation portion 520 are made closer to each other about the shaft 521 of the operation portion 520 as a rotational center. In the embodiment, the coil spring is employed as a biasing member. However, the biasing member is not limited to the coil spring as long as the biasing member which biases between the tilt portion 510 and the operation portion 520 is employed.

If the shafts 511 of the tilt portion 510 are fitted into and held by the first holding portions 111, the tilt portion 510 rotationally moves in the direction closer to the operation portion 520 by the biasing force of the coil spring 530. Further, the tilt portion 510 rotationally moves until the shafts 511 of the tilt portion 510 are positioned at the cutout ends 113b of the first holding portions 111.

In this manner, a state where the operation portion 520 is positioned at the front side and the tilt portion 510 is held in a state of being closer to the operation portion 520 corresponds to the state as illustrated in FIG. 8. Thus, the state where the tilt portion 510 is obliquely held corresponds to the first information input portion state.

As illustrated in FIG. 8 and FIG. 9, the operation portion 520 has an operation portion disengagement prevention portion 523 at a rear end. Further, the holding portions 110 have operation portion-disengagement prevention opposing portions 116. As illustrated in FIG. 8, the operation portion-disengagement prevention opposing portions 116 are arranged at positions corresponding to the rear end of the operation portion 520 in the first information input portion state. The operation portion-disengagement prevention opposing portions 116 suppress the operation portion 520 which has been moved in the front direction in the first information input portion state from being disengaged from the second holding portions 112.

On the other hand, if a user operates the information input portion 500 in the first information input portion state in the following manner, the operation portion 520 moves in the rear direction along the second holding portions 112. That is, if the user moves the operation portion 520 in the downward direction, cancels the positioning of the locking portions 522 of the operation portion 520 with respect to the first engagement portions 112a, and presses the operation portion 520 in the rear direction, the operation portion 520 moves in the rear direction along the second holding portions 112. Then, the shafts 511 of the tilt portion 510 also move in the obliquely upward direction to the rear side along the cutout portions 113 of the first holding portions 111 in conjunction with the movement of the operation portion 520.

At this time, the projections 514 on the position fixing portions 513 also move in the obliquely upward direction to the rear side. The grooves 115 are formed along trajectories of the movement of the projections 514 from the first information input portion state to the second information input portion state so as to guide the projections 514 preferably.

Subsequently, ends of the locking portions 522 of the operation portion 520 at the rear side reach to the second engagement portions 112b, ends of the locking portions 522 of the operation portion 520 at the upper side, the lower side, and the rear side are positioned.

Further, the projections 514 are fitted into the position fixing target portions 114 at a timing where the ends of the locking portions 522 of the operation portion 520 at the rear side reach to the second engagement portions 112b. Accordingly, in the second information input portion state, the information input portion 500 and the holding portions 110 are positioned, in addition to the first holding portions 111 and the second holding portions 112, by the position fixing target portions 114.

The projections 514 are fitted into the position fixing target portions 114 so that the tilt portion 510 is held in a substantially vertical state. The operation portion 520 tries to rotationally move in the direction closer to the tilt portion 510 by the biasing force of the coil spring 530. However, an angle between the tilt portion 510 and the operation portion 520 is kept to be an acute angle by configuring the second holding portions 112 to be gradually higher toward the rear side. Therefore, the shape of the information input portion 500 can be made stable. Further, upper faces of the second engagement portions 112b have enough contact areas with the locking portions 522 of the operation portion 520 to prevent the operation portion 520 from being rotationally moved. Such state corresponds to a state as illustrated in FIG. 9. The state where the tilt portion 510 is held substantially vertically in this manner corresponds to the second information input portion state.

As already described above, the information input portion 500 is bridged between and held by the holding portions 110. At this time, the tilt portion 510 is held by the pair of first holding portions 111 and the operation portion 520 on which a user performs operations is held by the pair of second holding portions 112. Accordingly, the operation portion 520 also serves as a beam on the holding portions 110 in addition to the tilt portion 510. The locking portions 522 of the operation portion 520 are formed so as to extend in the front and rear direction of the recording apparatus unit 10. With this, contact areas between the locking portions 522 and the second holding portions 112 are increased. Therefore, the operation portion 520 functions as a beam preferably even if the operation portion 520 moves.

It is to be noted that if the tilt portion 510 is moved from the second information input portion state to the first information input portion state, the projections 514 are disengaged from the position fixing target portions 114. The shapes of abutment faces of the projections 514 against the position fixing target portions 114 are devised so as not to make the projections 514 excessively difficult to be disengaged from the position fixing target portions 114 when the projections 514 are disengaged therefrom. In the embodiment, the abutment faces of the projections 514 against the position fixing target portions 114 are formed into spherical surfaces. Therefore, if a user tries to change the angle of the information input portion 500 from the first information input portion state to the second information input portion state, the user can disengage the projections 514 from the position fixing target portions 114 without feeling excessive load.

As described above, the user can operate the information input portion 500 between the first information input portion state and the second information input portion state. Accordingly, when the user uses the information input portion 500, the user can check the operation screen 502 and the operation buttons 501 of the tilt portion 510 from the obliquely upper side. Therefore, visibility can be improved. When the user does not use the information input portion 500, the tilt portion 510 is accommodated in a printer main body. This makes it possible to make the recording apparatus 1 compact.

### Second Embodiment

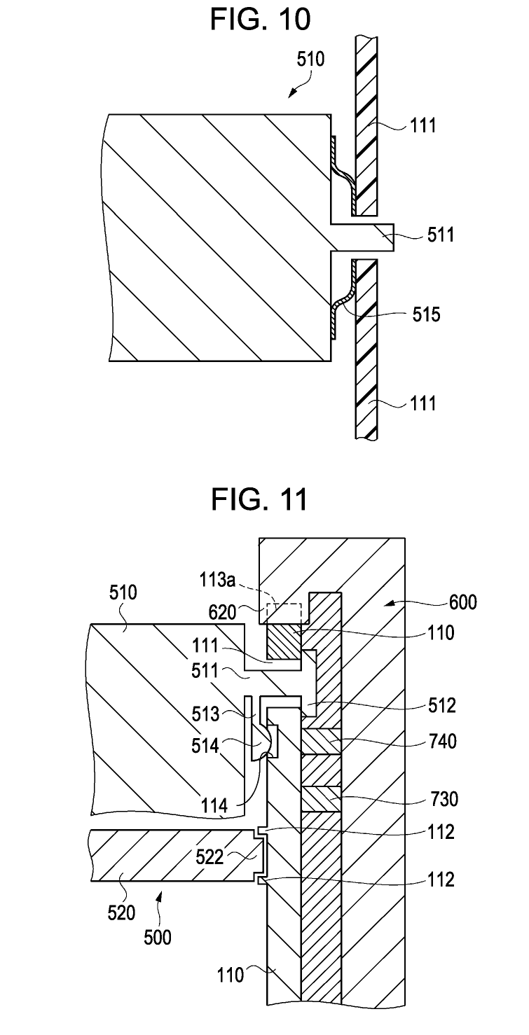

Subsequently, the second embodiment is described while focusing on a configuration in which the tilt portion 510 is suppressed from moving with respect to the first holding portions 111. FIG. 10 is a conceptual view illustrating a positional relationship between the first holding portions 111 and the tilt portion 510. Since portions which are denoted as the same reference numerals as those in FIGS. 6A and 6B have the same configurations as those in the embodiment of FIG. 8, description thereof is not repeated.

As illustrated in FIG. 10, plate springs 515 are arranged between the first holding portions 111 and the tilt portion 510. With this, the plate springs 515 pressurize the tilt portion 510 based on the first holding portions 111 so that the tilt portion 510 can be suppressed from moving with respect to the first holding portions 111. It is to be noted that the movement of the tilt portion 510 can be permitted in a range where the tilt portion 510 is suppressed from moving with respect to the first holding portions 111 with the pressurization of the plate spring 515.

In the embodiment, the plate springs are arranged between the first holding portions 111 and the tilt portion 510. However, the invention is not limited to the plate spring as long as an elastic member which can pressurize the tilt portion 510 based on the first holding portions 111 is employed.

### Third Embodiment

Subsequently, a third embodiment is described while focusing on a configuration relating to a positional relationship among the exterior member 600, the holding portions 110 and the tilt portion 510. FIG. 11 is a corresponding view of FIG. 4A according to the third embodiment. Since portions which are denoted as the same reference numerals as those in FIG. 4A have the same configurations as those in the embodiment of FIG. 4A, description thereof is not repeated.

As illustrated in FIG. 11, the rigidity of the holding portions 110 can be complemented by making the holding portions 110 and the exterior member 600 abut against each other through abutment members 730, 740 even if the holding portions 110 and the exterior member 600 do not abut against each other directly. The abutment members 730, 740 abut against the holding portions 110 and the exterior member 600. The abutment members 730, 740 correspond to the abutment portions 630, 640, respectively. Further, the abutment members 730, 740 are fixed to either of the holding portions 110 or the exterior member 600 with a well-known adhesive, for example. It is to be noted that the fixing method of the abutment members 730, 740 is not limited to the method using adhesive as long as the abutment members 730, 740 can be fixed. For example, the abutment members 730, 740 may be fixed by screwing.

In the embodiment, a material of the abutment members 730, 740 which abut against the holding portions 110 and the exterior member 600, which is different from materials of the holding portions 110 or the exterior member 600, can be selected. A material which is more suitable for improving rigidity of the base portion 100 can be selected for the abutment members 730, 740.

Embodiments of the invention have been described above. However, the invention is not limited to the above embodiments. It is needless to say that the invention is applied to other embodiments in the range described in the aspect of the invention. For example, in the above embodiments, the printer has been described as an example as the recording apparatus. However, the recording apparatus is not limited to the printer and the invention can be applied to a copying machine, for example, as long as a recording apparatus which can rotationally move with respect to the base portion and uses the information input portion which instructs to execute recording is employed.

The entire disclosure of Japanese Patent Application No: 2010-218341, filed Sep. 29, 2010 is expressly incorporated by reference herein.

What is claimed is:

1. A recording apparatus comprising:
a recording portion which executes recording on a medium;
a feeding portion which feeds the medium to the recording portion;
a discharge portion on which the medium on which the recording has been executed is discharged;
a base portion which holds the recording portion, the feeding portion, and the discharge portion;
an exterior member which covers at least a portion of the base portion;
an information input portion which instructs to execute the recording;
a pair of holding portions which are provided on the base portion, bridge the information input portion, hold the information input portion on the base portion, and
a fixing mechanism which fixes the information input portion to the pair of the holding portions in an axial direction of a rotational shaft of the information input portion.

2. The recording apparatus according to claim 1,
wherein the recording portion has a carriage on which a recording head is mounted and a supporting portion which supports the carriage, and
the pair of holding portions are provided so as to be separated from the supporting portion.

3. The recording apparatus according to claim 2, further including a pressurization member which is provided between the information input portion and the holding portions and pressurizes the information input portion and the holding portions.

4. The recording apparatus according to claim 2,
wherein the shaft of the information input portion is held on the holding portions in a rotationally movable manner.

5. The recording apparatus according to claim 4,
wherein the shaft of the information input portion has a pair of shaft disengagement prevention portions which prevent the shaft from being disengaged from the holding portions in the axial direction of the shaft, and
the pair of shaft disengagement prevention portions and the pair of holding portions are pressurized against each other.

6. The recording apparatus according to claim 5,
wherein the pair of shaft disengagement prevention portions and the pair of holding portions are pressurized against each other in a state where the holding portions are elastically deformed in the axial direction of the rotational shaft of the information input portion.
